(19) United States
(12) Patent Application Publication
(10) Pub. No.: US 2012/0079683 A1
(43) Pub. Date: Apr. 5, 2012

(54) SELF-LUBRICATING DOOR HINGE PIN

(76) Inventor: Kenneth L. Spragg, Woodstock (CA)

(21) Appl. No.: 13/167,815

(22) Filed: Jun. 24, 2011

Related U.S. Application Data
(63) Continuation-in-part of application No. 29/390,516, filed on Apr. 26, 2011, now Pat. No. D649010.
Application No. 29/390,516 is a continuation-in-part of application No. 29/390,523, filed on Apr. 26, 2011, now Pat. No. D649430.
(60) Provisional application No. 61/388,775, filed on Oct. 1, 2010.

(51) Int. Cl. E05D 11/02

(52) U.S. Cl. 16/274

(57) ABSTRACT

A hinge pin for pivotally connecting a door to a frame comprises a pin body extending along a pivot axis between first and second ends, and a grease nipple portion extending longitudinally from the first end of the pin body. The pin body has an outer bearing shaped to enable the door to pivot relative to the frame about the pivot axis, a cross-bore extending radially inward from the outer bearing surface into the pin body, and a longitudinal bore extending into the pin body from the first end to the cross-bore. The longitudinal bore and the cross-bore together form a lubrication passageway. The pin body also has coupling portions for coupling the pin body to the door and the frame. The grease nipple portion is shaped to be coupled to a grease applicator for injecting grease into the lubrication passageway and is integrally formed with the pin body.

### RELATED APPLICATIONS

This application claims the benefit of U.S. Provisional Patent Application No. 61/388,775 filed Oct. 1, 2010 and entitled “SELF-LUBRICATING DOOR HINGE PIN”, the entire contents of which are incorporated herein by reference for all purposes, and is a continuation-in-part of US Design Patent Application No. 29/390,516, filed Apr. 26, 2011 and entitled “DOOR HINGE PIN”, the entire contents of which are incorporated herein by reference for all purposes, and is a continuation-in-part of US Design Patent Application No. 29/390,523, filed Apr. 26, 2011 and entitled “DOOR HINGE PIN”, the entire contents of which are incorporated herein by reference for all purposes.

### TECHNICAL FIELD

The invention relates to hinge pins, and in particular to self-lubricating door hinge pins.

### BACKGROUND

Hinge pins provide a fixed axis of rotation for objects to pivot about and are commonly used for installing automobile doors and other doors. Typically, hinge pins have a bearing surface that pivotally engages a knuckle on the door so that the door can pivot between an open and closed position. Unfortunately, hinge pins tend to rust and wear down over time, which can cause the pin to seize or break at or near the bearing surface because the hinge pin is subject to repeated frictional loads when opening and closing the door.

One method of reducing premature wear and breaking of the hinge pin is to apply a lubricant to the bearing surface. Unfortunately, the lubricant eventually deteriorates, depletes, or otherwise loses its effectiveness. It is possible to reapply the lubricant, however, the construction of the door hinge makes it difficult to ensure the lubricant actually reaches the bearing surface. As such, each reapplication may require disassembly of the door, which is time consuming and cumbersome.

There have been some attempts to provide self-lubricating hinge pins. For example, U.S. Pat. No. 5,771,538 (Huppert, Sr.) discloses a lubricated hinge pin having a hollow cylindrical body for receiving grease and a plurality of ports through the cylindrical body to lubricate an object attached to the pin, such as one or more rotating knuckles. The bottom and top ends of the hollow body are threaded for receiving a threaded bolt on the upper end, and a threaded grease fitting on the lower end. According to Huppert, Sr., the threaded fittings on both ends allow easy removal of grease by inserting a grease-removing instrument through the entire extent of the cylindrical body. Unfortunately, the removable threaded fittings represent small gaps for lubricant to leak out of, which reduces the effectiveness of the lubricant and may reduce the lifespan of the hinge pin. The removable threaded fittings can also be lost, damaged, or misplaced when assembling or disassembling the hinge pin for cleaning or otherwise.

Accordingly, there is a need for improved door hinge pins, and in particular, an improved self-lubricating door hinge pin.

### SUMMARY OF THE INVENTION

According to one aspect of the present invention there is provided a hinge pin for pivotally connecting a door to a frame. The hinge pin comprises a pin body extending along a pivot axis between a first end and an opposing second end. The pin body has an outer bearing surface located between the first and second ends. The bearing surface is shaped to enable the door to pivot relative to the frame about the pivot axis. The pin body also has at least one cross-bore extending radially inward from the outer bearing surface into the pin body, and a longitudinal bore extending into the pin body from the first end to the cross-bore. The longitudinal bore and the cross-bore together form a lubrication passageway extending from the first end of the pin body to the outer bearing surface. The pin body also has coupling portions for coupling the pin body to the door and the frame. The hinge pin also comprises a grease nipple portion extending longitudinally from the first end of the pin body. The grease nipple portion is shaped to be coupled to a grease applicator for injecting grease into the lubrication passageway. The grease nipple portion is integrally formed with the pin body.

In some embodiments the lubrication passage may have a diameter greater than about 1/16 of an inch, or a diameter of between about 1/16 of an inch and ⅛ of an inch.

In some embodiments the longitudinal bore has a bottom, and the cross-bore may intersect the longitudinal bore at the bottom of the longitudinal bore.

In some embodiments the grease nipple portion may have a bulbous shape. For example, the grease nipple portion may be shaped as a truncated bicone.

In some embodiments, the coupling portions may comprise a first coupling portion for pivotally coupling the pin body to one of the door and the frame, and a second coupling portion for fixedly coupling the pin body to the other of the door and the frame.

According to another aspect of the present invention there is provided a kit for pivotally connecting a door to a frame. The kit comprises an upper hinge pin and a lower hinge pin. Each of the upper and lower hinge pins comprises a pin body extending along a pivot axis between a first end and an opposing second end. The pin body has an outer bearing surface located between the first and second ends. The bearing surface is shaped to enable the door to pivot relative to the frame about the pivot axis. The pin body also has at least one cross-bore extending radially inward from the outer bearing surface into the pin body, and a longitudinal bore extending into the pin body from the first end to the cross-bore. The longitudinal bore and the cross-bore together form a lubrication passageway extending from the first end of the pin body to the outer bearing surface. The pin body also has coupling portions for coupling the pin body to the door and the frame. Each hinge pin also comprises a grease nipple portion extending longitudinally from the first end of the pin body. The grease nipple portion is shaped to be coupled to a grease applicator for injecting grease into the lubrication passageway. The grease nipple portion is integrally formed with the pin body.

In some embodiments the kit may further comprise a hinge strap for securing the door to the upper hinge pin and the lower hinge pin.

In some embodiments, the coupling portions may comprise a first coupling portion for pivotally coupling the pin body to one of the door and the frame, and a second coupling portion for fixedly coupling the pin body to the other of the door and the frame.

Other aspects and features of the invention will become apparent, to those ordinarily skilled in the art, upon review of the following description of some exemplary embodiments.

### BRIEF DESCRIPTION OF THE DRAWINGS

The invention will now be described, by way of example only, with reference to the following drawings, in which:

FIG. 1 is a partially exploded perspective view a door being installed on a vehicle frame using an upper and lower hinge pin made in accordance with an embodiment of the present invention; and

FIG. 2 is a perspective view of the upper hinge pin of FIG. 1;

FIG. 3 is a cross-sectional view of the upper hinge pin of FIG. 1;

FIG. 4 is a perspective view of the lower hinge pin of FIG. 1;

FIG. 5 is a cross-sectional view of the lower hinge pin of FIG. 1;

FIG. 6 is an exploded view of the upper and lower hinge pins being installed on the vehicle frame as shown in FIG. 1;

FIG. 7 is a perspective view of an upper hinge pin made in accordance with another embodiment of the present invention;

FIG. 8 is a perspective view of a lower hinge pin made in accordance with another embodiment of the present invention;

FIG. 9 is a side elevation view of a hinge pin made in accordance with another embodiment of the present invention;

FIG. 10 is a side elevation view of a hinge pin made in accordance with another embodiment of the present invention;

FIG. 11 is a side elevation view of a hinge pin made in accordance with another embodiment of the present invention;

FIG. 12 is a side elevation view of a hinge pin made in accordance with another embodiment of the present invention; and

FIG. 13 is a partial cross-sectional side elevation view of a hinge pin made in accordance with another embodiment of the present invention.

### DETAILED DESCRIPTION OF THE INVENTION

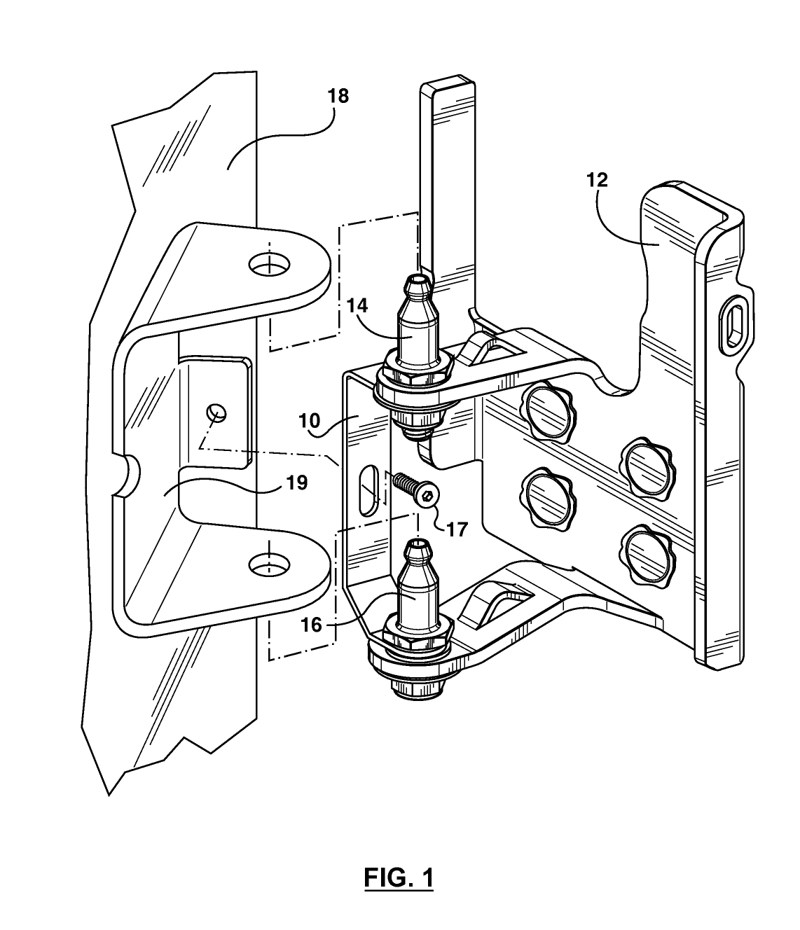

Referring to FIG. 1, illustrated therein is a door hinge strap 10 installed on a portion of a vehicle frame 12 using an upper hinge pin 14 and a lower hinge pin 16 made in accordance with an embodiment of the present invention. The hinge pins 14 and 16 are sized and shaped to support a door 18, which can be installed on the vehicle frame as indicated in FIG. 1. In particular, the door 18 includes a door bracket 19 having two spaced apart arms with apertures therein. The door bracket 19 can be installed on the hinge pins 14 and 16 so that the top ends of the hinge pins 14 and 16 slide through the apertures in each respective arm as shown by the phantom lines in FIG. 1. The hinge strap 10 can then be used to secure the door 18 to the hinge pins 14 and 16 by inserting a bolt 17 through corresponding apertures in the hinge strap 10 and the door bracket 19.

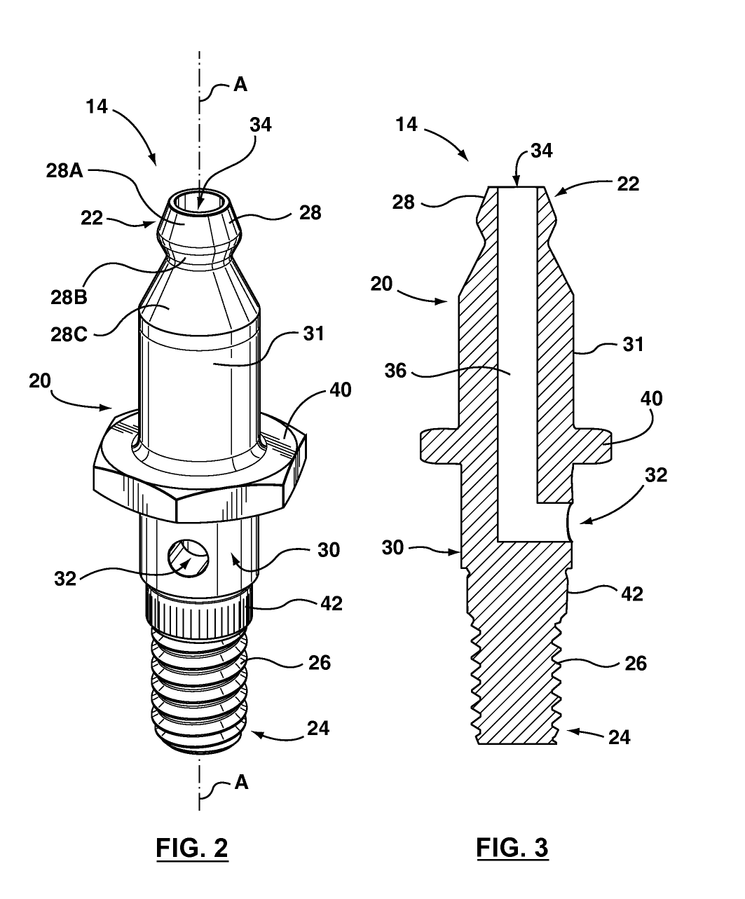

Referring now to FIGS. 2 and 3, the upper hinge pin 14 will be described in greater detail.

The upper door hinge pin 14 includes a pin body 20 extending longitudinally along a pivot axis A between a first end 22 and an opposing second end 24, and a grease nipple portion 28 extending longitudinally from the first end 22 of the pin body 20. The grease nipple portion 28 is shaped to receive and be coupled to the end of a grease applicator (not shown) such as a grease gun. In the illustrated embodiment, the grease nipple portion 28 is integrally formed with the pin body 20. In other embodiments, the grease nipple portion 28 might be a separate grease fitting fixedly attached to the pin body 20.

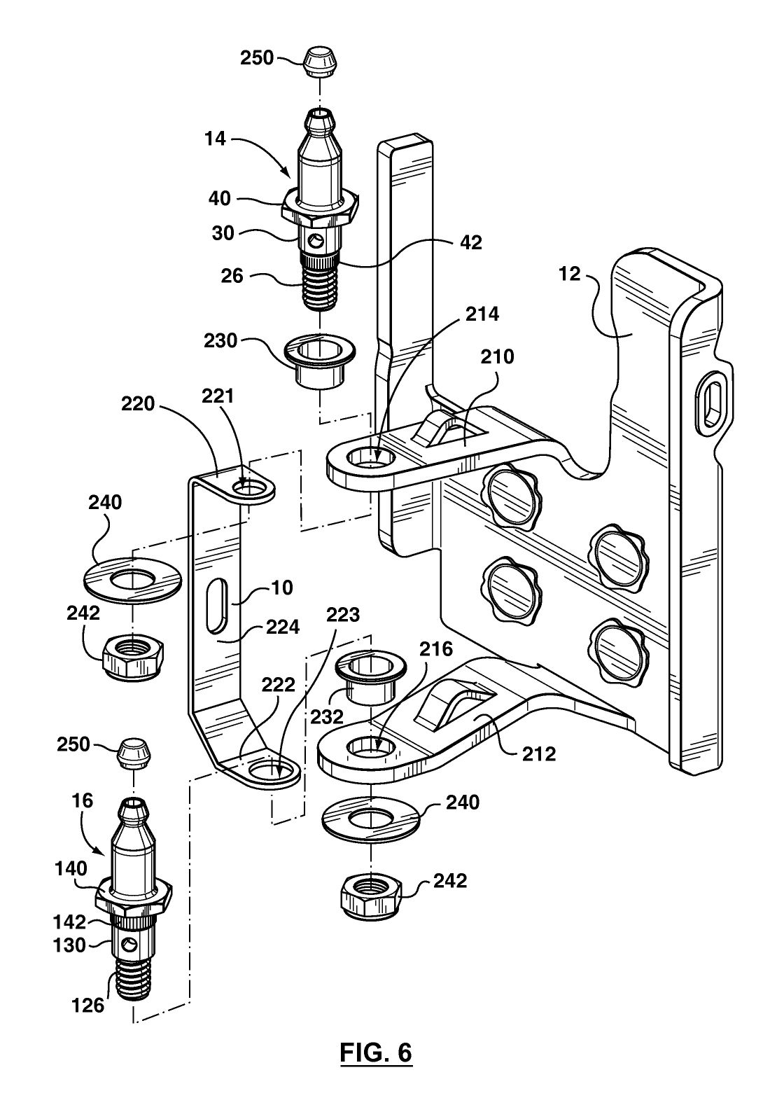

The pin body 20 also has an outer bearing surface 30 located between the first and second ends 22 and 24. The outer bearing surface 30 is generally shaped to enable the door 18 to pivot relative to the frame 12 about the pivot axis A. In some embodiments, the outer bearing surface 30 may be sized and shaped to fit into a bushing 230 (shown in FIG. 6) when installing the hinge pin 14 on the vehicle frame 12. The bushing 230 may help provide smooth pivoting of the door 18 relative to the frame 12.

The pin body 20 also has a first coupling portion in the form of a shank portion 31 located between the bearing surface 30 and the first end 20 for fixedly coupling the hinge pin 14 to the door 18. The shank portion 31 is sized and shaped to fit through the apertures in a door bracket 19 (as shown in FIG. 1) so as to support the door 18 when it is attached to the vehicle frame 12.

Generally, the pin body 20 has a cylindrical shape such that the outer bearing surface 30 and the shank portion 31 both have circular cross-sections aligned with the pivot axis A, which enables the door 18 to pivot relative to the frame 12 about the pivot axis A.

The pin body 20 also has a cross-bore 32 extending radially inward from the outer bearing surface 30 into the pin body 20, and a longitudinal bore (e.g. a central bore 34) extending longitudinally into the pin body 20 from the first end 22 of the pin body 20 to the cross-bore 32 (i.e. to an intermediate position between the first and second ends 22 and 24 of the pin body 20). The cross-bore 32 and the central bore 34 together form a lubrication passageway 36 extending from the first end 22 of the pin body 20 to the outer bearing surface 30. While the pin body 20 of the illustrated embodiment has one cross-bore 32, in some embodiments, the pin body 20 may have more than one cross-bore.

The grease nipple portion 28 is in fluid communication with the lubrication passageway 36 so that a lubricant can be injected into the lubrication passageway 36 by attaching a grease gun (not shown) to the grease nipple portion 28. In use, lubricant flows down through the central bore 34 and outward through the cross-bore 32 to the outer bearing surface 30 so as to provide lubrication.

As shown in the illustrated embodiment, the cross-bore 32 may intersect the central bore 34 at or near the bottom of the central bore 34. This helps prevent pooling of lubricant in the bottom of the central bore 34 and can thereby increase the effectiveness of the lubricant.

In some embodiments, the grease nipple portion 28 and the lubrication passage 36 may be sized and shaped to receive an extreme pressure grease (e.g. a thick viscosity grease). For example, the lubrication passage 36 (e.g. the central bore 34 and/or cross-bore 32) may have a diameter greater than about 1/16 of an inch, or more preferably between about 1/16 of an inch and ⅛ of an inch.

In some embodiments, the grease nipple portion 28 may have a bulbous shape. For example, as shown in FIG. 2, the grease nipple portion 28 may be shaped as a “truncated bicone”, meaning that the grease nipple portion 28 has a first upright frustoconical surface 28A and a second inverted frustoconical surface 28B. As shown, the first frustoconical surface 28A tapers outward as it extends from the first end 22 toward the second frustoconical surface 28B, and the second frustoconical surface 28B tapers inward as it extends from the first frustoconical surface 28A toward the shank portion 31. As shown, there may also be a third frustoconical surface 28C that tapers outward as it extends from the second frustoconical surface 28B to the shank portion 31.

The pin body 20 also has a second coupling portion for pivotally coupling the pin body 20 to the vehicle frame 12. In the illustrated embodiment, the second coupling portion includes a flange 40 and a threaded portion 26 for receiving a threaded fastener (such as a torque prevailing nut 242 as shown in FIG. 6) so as to couple the pin body 20 to the frame 12 between the flange 40 and the threaded fastener. For example, as shown in FIG. 6, an upper mounting plate 210 of the vehicle frame 12 is secured between the flange 40 and the torque prevailing nut 242.

In the illustrated embodiment, the threaded portion 26 is located proximal to the second end 24 of the pin body 20, and the flange 40 is located on the pin body 20 between the first and second ends 22, 24, and in particular, between the shank portion 31 and the outer bearing surface 30. In other embodiments, the threaded portion 26 and the flange 40 may have other locations on the pin body 20 as will be described below.

The flange 40 is radially wider than the rest of the pin body 20 and provides a mounting point for attaching the upper hinge pin 14 to the vehicle frame 12. As shown, the flange 40 may have a hexagonal cross-section that is shaped to receive a wrench, for example, to help tighten the torque prevailing nut 242 when affixing the upper hinge pin 14 to the vehicle frame 12.

The upper hinge pin 14 also includes a friction surface 42 for fixedly coupling the pin body 20 to the door 18. Generally, the friction surface 42 is located on the pin body 20 between the first and second ends 22, 24. In the illustrated embodiment, the friction surface 42 is located between the outer bearing surface 30 and the threaded portion 26. In other embodiments, the friction surface 42 may have different locations on the hinge pin, for example, as will be described below with reference to the lower hinge pin 16.

The friction surface 42 is sized and shaped to fit into an aperture 221 in the hinge strap 10 (shown in FIG. 6) so that the hinge pin 14 frictionally engages the hinge strap 10 and prevents relative movement therebetween. The hinge strap 10 is then secured to the door bracket 19 (e.g. using the bolt 17 as shown in FIG. 1), which secures the hinge pin 14 to the door 18.

As shown, the friction surface 42 is formed by longitudinal ridges and grooves extending along the pin body 20. The ridges tend to frictionally engage the aperture 221 in the hinge strap 10. In other embodiments, the friction surface 42 may be formed in different ways, for example using a knurled surface, crisscrossing grooves, dimples, and the like.

The friction surface 42 has a smaller diameter than the bearing surface 30, which facilitates installation and operation of the hinge pin 14. In particular, when installing the hinge pin 14 on the vehicle frame 12, the hinge pin 14 slides into the bushing 230 (see FIG. 6) so that the bearing surface 30 registers with the inner annular surface of the bushing 230. Furthermore, the smaller diameter friction surface 42 is sized smaller than the inner circumference of the bushing 230 (see FIG. 6) so that the friction surface 42 slides through the bushing 230 and fits firmly into an aperture 221 within the hinge strap 10. The friction surface 42 is sized to provide an interference fit with the aperture 221 so as to frictionally engage the hinge strap 10, but not the bushing 230. Frictional engagement between the friction surface 42 and the aperture 221 can reduce or prevent relative movement between the hinge pin 14 and the hinge strap 10, which can help secure the hinge pin 14 to the door 18.

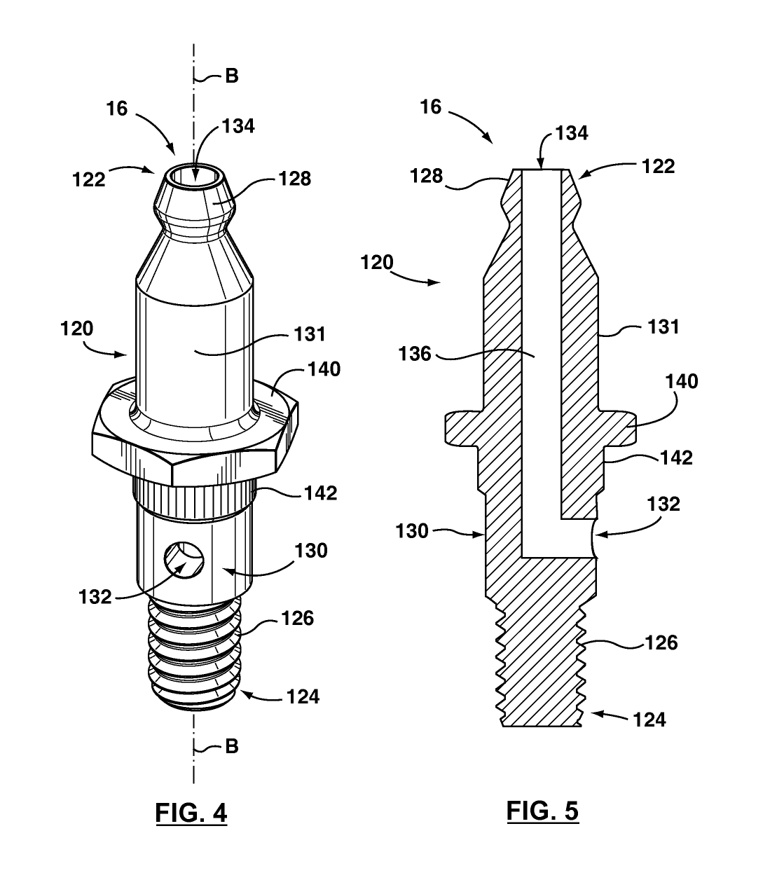

Referring now to FIGS. 4 and 5, the lower hinge pin 16 will be described. The lower hinge pin 16 is similar in many respects to the upper hinge pin 14 and similar elements have similar reference numerals incremented by one hundred.

The lower hinge pin 16 includes an elongate pin body 120 extending longitudinally along a pivot axis B between a first end 122 and an opposing second end 124, and a grease nipple portion 128 extending longitudinally from the first end 122 of the pin body 120. The grease nipple portion 128 is shaped to receive and be coupled to the end of a grease applicator (not shown) such as a grease gun. In the illustrated embodiment, the grease nipple portion 128 is integrally formed with the pin body 120. In other embodiments, the grease nipple portion 128 might be a separate grease fitting fixedly attached to the pin body 120.

The pin body 120 has an outer bearing surface 130 located between the first and second ends 122 and 124, and a shank portion 131 located between the bearing surface 130 and the first end 120.

Furthermore, the pin body 120 also has a cross-bore 132 extending radially inward from the outer bearing surface 130 into the pin body 120 and a longitudinal bore (e.g. a central bore 134) extending longitudinally into the pin body 120 from the first end 122 of the pin body to the cross-bore 132 (i.e. to an intermediate position between the first and second ends 122 and 124 of the pin body 120). The cross-bore 132 and the central bore 134 together form a lubrication passageway 136 extending from the first end 122 of the pin body 120 to the outer bearing surface 130.

The grease nipple portion 128 is in fluid communication with the lubrication passageway 136 so that a lubricant can be injected into the lubrication passageway 136 by attaching a grease gun (not shown) to the grease nipple portion 128. When the hinge pin 16 is installed and in use, lubricant flows down through the central bore 134 and outward through the cross-bore 132 to the outer bearing surface 130 so as to provide lubrication.

In some embodiments, the grease nipple portion 128 and the lubrication passage 136 may be sized and shaped to receive an extreme pressure grease. For example, the lubrication passage 136 (e.g. the central bore 134 and/or cross-bore 132) may have a diameter greater than about 1/16 of an inch, or more preferably between about 1/16 of an inch and ⅛ of an inch.

In some embodiments, the grease nipple portion 128 may have a bulbous shape. For example, as shown in the illustrated embodiment, the grease nipple portion 128 may be shaped as a truncated bicone.

The lower hinge pin 16 also includes a flange 140 and a threaded portion 126 for pivotally coupling the pin body 120 to the vehicle frame 12. In the illustrated embodiment, the threaded portion 126 is located proximal to the second end 124 of the pin body 120. The hinge pin 16 also includes a friction surface 142 located on the pin body 120 between the first and second ends 122 and 124.

One difference between the upper hinge pin 14 and the lower hinge pin 16 is the location of the flange 140 and the friction surface 142. In particular, the flange 140 of the lower hinge pin 16 is located between the shank portion 131 and the friction surface 142, and the friction surface 142 is located between the flange 140 and the outer bearing surface 130.

Another difference is that the friction surface 142 has a larger diameter than the bearing surface 130, which facilitates installation and operation of the lower hinge pin 16. Similar to the upper hinge pin 14, the lower hinge pin 16 slides into the bushing 232 so that the bearing surface 130 registers with the inner annular surface of the bushing 232 so as to enable the door 18 to pivot relative to the frame 12 about the pivot axis B. Furthermore, the larger diameter friction surface 142 is sized to provide an interference fit with the aperture 223 in the hinge strap 10 (shown in FIG. 6), but the larger diameter friction surface 142 does not slide into the bushing 232 and instead rests above the bushing 232. This prevents the friction surface 142 from engaging both the hinge strap 10 and the bushing 232, which might otherwise impede smooth operation of the hinge.

Referring to FIG. 6, the installation of the hinge strap 10 on the vehicle frame 12 using the upper and lower hinge pins 14 and 16 will now be described in greater detail.

The vehicle frame 12 includes a generally vertical plate having an upper mounting plate 210 and a lower mounting plate 212 extending laterally outward from the vertical plate. The upper and lower mounting plates 210 and 212 are spaced apart from each other. The mounting plates 210 and 212 have apertures 214 and 216 that are axially aligned with each other. The apertures 214 and 216 are sized and shaped to receive the hinge pins 14 and 16 and corresponding bushings 230 and 232.

The hinge strap 10 has a body portion 224, and upper and lower arms 220 and 222 that are spaced apart on opposite sides of the body portion 224 so as to fit between the upper and lower mounting plates 210 and 212. When the hinge strap 10 slides between the mounting plates 210 and 212, the upper arm 220 is adjacent to the upper mounting plate 210, and the lower arm 222 is adjacent to the lower mounting plate 212. Furthermore, the upper and lower arms 220 and 222 of the hinge strap 10 have apertures 221 and 223 aligned with the apertures 214 and 216 in the mounting plates 210 and 212.

Prior to placing the hinge strap 10 between the upper and lower mounting plates 210 and 212, bushings 230 and 232 are placed in the apertures 214 and 216 on the upper and lower mounting plates 210 and 212. The bushings 230 and 232 are circular in cross-section and have an outer diameter sized to fit snugly within the apertures 214 and 216. Furthermore, the bushings 230 and 232 have an internal diameter sized and shaped to receive the bearing surfaces 30 and 130 of the upper and lower hinge pins 14 and 16, as will be described below.

Next the hinge strap 10 is positioned between the upper and lower mounting plates 210 and 212. The upper pin 14 is then placed through the first bushing 230. A threaded fastener such as a standard nut (not shown) can be threaded onto the threaded portion 26 of the hinge pin 14 so as to draw the hinge pin 14 and the bushing 230 into the aperture 214 of the upper mounting plate 210. While tightening the standard nut to seat the hinge pin 14 and the bushing 230 in the aperture 214, a wrench can be used on the hexagonal shaped flange 40 of the upper hinge pin 14. The standard nut also draws the friction surface 42 into the aperture 221.

Once the upper hinge pin 14 and bushing 230 have been seated, the standard nut is removed, and a washer 240 is placed over the threaded portion 26 of the hinge pin 14. A torque prevailing nut 242 or a lock nut can then be installed on the threaded portion 26 of the hinge pin 14 to secure the hinge pin 14 in place. In some embodiments, the washer 240 may be omitted.

When the upper hinge pin 14 is installed, the threaded portion 26 extends below the bushing 230 and the bearing surface 30 is generally aligned with the inner surface of the bushing 230. Accordingly, the flange 40 of the hinge pin 14 abuts the top surface of the bushing 230. Furthermore, the friction surface 42 of the hinge pin 14 is firmly seated within the aperture 221 in the upper arm 220 of the hinge strap 10. Accordingly, the friction surface 42 engages the upper arm 220 of the hinge strap 10 and prevents relative movement between the upper hinge pin 14 and the hinge strap 10.

The installation of the lower hinge pin 16 is similar to the upper hinge pin 14. One difference is the location of the lower bushing 232, which is positioned between the lower mounting plate 212 and the lower arm 222 of the hinge strap 10. In contrast, the upper bushing 230 is positioned between the upper mounting plate 210 and the flange 40 of the upper hinge pin 14.

While FIG. 6 shows the bushings 230 and 232 having flanges resting adjacent to the top surfaces of the mounting plates 210 and 212, in other embodiments, one or both of the bushings 230 and 232 may be flipped upside-down so that the flanges are adjacent to the bottom surfaces of the mounting plates 210 and 212.

Once the upper and lower hinge pins 14 and 16 have been installed, the door 18 can be installed by placing the door bracket 19 over the top ends of the hinge pins 14 and 16 so that apertures in the door bracket 19 slide over and engage the shank portions 31 and 131 of the hinge pins 14 and 16 as shown in FIG. 1.

A grease gun can then be attached to each of the grease nipple portions 28 and 128 of the hinge pins 14 and 16 so as to apply lubricant to the hinge pins. Generally, lubricant is applied until some lubricant is seen around the bushings 230 and 232. Dust caps 250 can then be placed over the grease nipple portions 28 and 128 to seal the lubricant within the hinge pins and prevent debris from entering the hinge pins.

After installation, there is usually a close fit between the bushings 230 and 232 and the bearing surfaces 30 and 130 of the hinge pins 14 and 16. This close fit tends to cause friction when opening and closing the vehicle door, which frequently results in wear and structural failure of conventional door hinges. The hinge pins 14 and 16 described herein tend to reduce friction because lubricant seeps through the lubrication passageways 36 and 136 and out the cross-bores 32 and 132 to lubricate the bearing surfaces 30 and 130 and the inner annular surface of the bushings 230 and 232. Furthermore, once the lubricant within the hinge pins deteriorates or depletes, more lubricant can be added by removing the dust caps 250 and reapplying lubricant using a grease gun. There is no need to disassemble the hinge when reapplying lubricant.

One benefit of the hinge pins 14 and 16 is that the grease nipple portions 28 and 128 are integrally formed with the pin bodies 20 and 120. As such, the grease nipple portions tend to stay attached to the pin bodies and are always in place when re-applying lubricant. This prevents the grease nipples from being lost or misplaced. Integrally forming the grease nipple portions 28 and 128 with the pin bodies 20 and 120 also tends to reduce manufacturing costs because only one part is manufactured, opposed to two separate pieces. Furthermore, the integral grease nipple has no moving parts, such as springs and ball check valves.

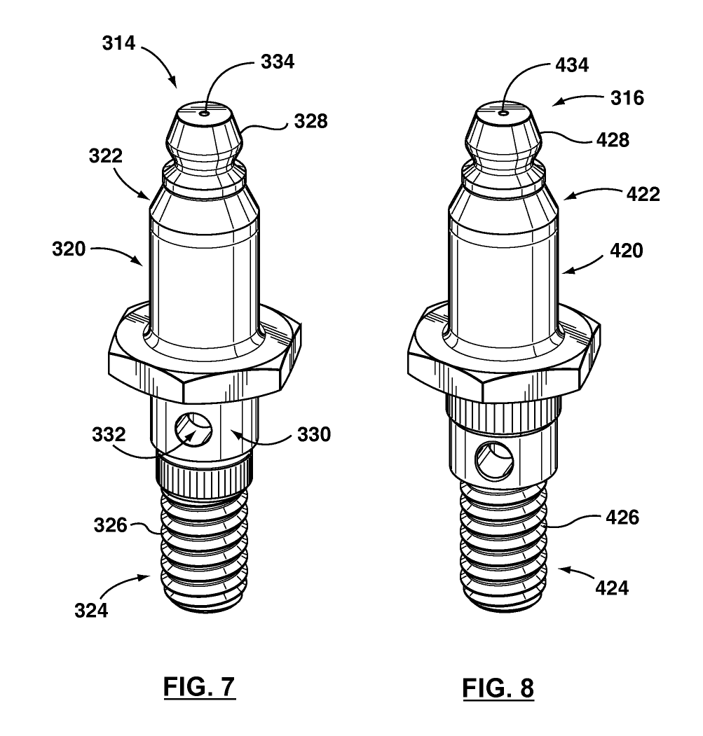

While the hinge pins illustrated in FIGS. 1-6 have grease nipple portions integrally formed with the pin body, in other embodiments, the grease nipple portions may be attached to the pin body as separate grease fittings. For example, referring to FIGS. 7 and 8, illustrated therein are upper and lower hinge pins 314 and 316 made in accordance with another embodiment of the present invention. The hinge pins 314 and 316 are similar in many respects to the hinge pins 14 and 16 described previously, and similar elements are given similar reference numerals incremented by three hundred and four hundred respectively.

The upper hinge pin 314 includes a pin body 320 having a first end 322 and a second end 324, a threaded portion 326 located proximal to the second end 324 of the pin body 320, and a grease nipple portion 328 located proximal to the first end 322 of the pin body 320.

The pin body 320 has an outer bearing surface 330 located between the first and second ends 322 and 324. The grease nipple portion 328 has a longitudinal bore (e.g. a central bore 334) that extends through the grease nipple portion 328 and continues to extend longitudinally into the pin body 320 from the first end 322 of the pin body to an intermediate position between the first and second ends 322 and 324 of the pin body. At or near the bottom of the central bore 334, a cross-bore 332 extends radially outward from the central bore 334 to the outer bearing surface 330. The cross-bore 332 and the central bore 334 together form a lubrication passageway 336.

One difference between the upper hinge pin 314 and the upper hinge pin 14 described previously is that the grease nipple portion 328 is a separate grease fitting fixedly attached to the pin body 320, such as a Zerk fitting. In the illustrated embodiment, the grease fitting 328 has been screwed into the central bore 334 of the pin body 320 using a threaded fit. In other embodiments, the grease fitting 328 may be fixedly attached to the pin body 320 in different ways, for example, using a press fit, welds, epoxy and other adhesives, and the like.

Generally, the grease fitting 328 includes a one-way valve (not shown). Accordingly, a grease gun can be attached to the one-way valve for injecting lubricant into the lubrication passageway. When the grease gun is detached, the one-way valve retains the lubricant within the lubrication passageway. The valve may be formed using a spring-loaded ball that is fitted within the central bore 334 of the grease fitting 328 as known to a person skilled in the art.

Another difference between the upper hinge pin 314 and the upper hinge pin 14 described previously is that the central bore 334 extending through the grease fitting 328 has a smaller diameter in comparison to the central bore 34 through the integral grease nipple portion 28. This is because the separate grease fitting 328 has a threaded end that screws into the pin body 320 and the portion of the central bore through the grease fitting 328 has a smaller diameter than the diameter of the threaded end.

Referring now to FIG. 8, the lower hinge pin 316 includes a pin body 420 having a first end 422 and a second end 424, a threaded portion 426 located proximal to the second end 424 of the pin body 420, and a grease nipple portion 428 located proximal to the first end 422 of the pin body 420.

Like the upper hinge pin 314, the grease nipple portion 428 of the lower hinge pin 316 is a separate piece that has been screwed into the pin body 420. Furthermore, the lower hinge pin 316 has a longitudinal bore (e.g. a central bore 434) extending through the grease nipple portion 428 that is smaller than the central bore 134 of the integral grease nipple portion 128 of the lower hinge pin 16 described previously.

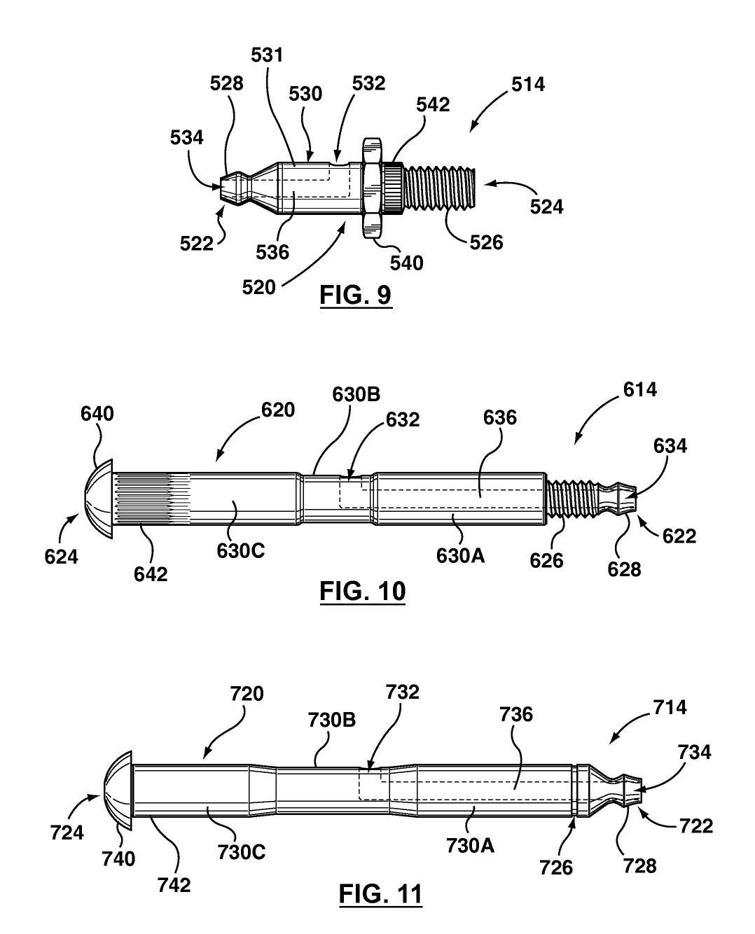

In some embodiments, various portions (e.g. the threaded portion, cross-bore, flange, and friction surface) of the hinge pin may have other configurations, shapes, locations as will be described below with reference to FIGS. 9-13.

Referring to FIG. 9, illustrated therein is a hinge pin 514 made in accordance with another embodiment of the present invention. The hinge pin 514 is similar in many respects to the hinge pin 114 described previously with reference to FIGS. 4 and 5, and similar elements have similar reference numerals incremented by four hundred. In particular, the hinge pin 514 includes a pin body 520 having a first end 522 and a second end 524, a threaded portion 526, a grease nipple portion 528, an outer bearing surface 530, a cross-bore 532 and a longitudinal bore 534 defining a lubrication passageway 536, a flange 540, and a friction surface 542.

One difference is that the bearing surface 530 is located between the first end 522 and the flange 540 (i.e. in the same location as the shank portion 131 of the hinge pin 14). Accordingly, the cross-bore 532 is located closer to the first end 526 in comparison to the cross-bore 132, and the longitudinal bore 534 is generally shorter in comparison to the central bore 134.

During installation, the hinge pin 514 is generally fixedly coupled to the vehicle frame 12 using a first coupling portion in the form of the flange 540, friction surface 542, and a threaded fastener (e.g. a torque prevailing nut 242) received on the threaded portion 526. Afterwards, the door 18 is pivotally coupled to the hinge pin 514 using a second coupling portion in the form of the shank portion 531, which slides through an aperture on the door bracket 19. Once installed, the door bracket 19 rests on the flange 540 such that the door bracket 19 aligns with the bearing surface 530, which enables the door 18 to pivot about the bearing surface 530 of the hinge pin 514. Accordingly, the hinge pin 514 is pivotally coupled to the door 18 and is fixedly coupled to the frame 12. This is in contrast to the hinge pin 14 described with reference to FIG. 6, which is fixedly coupled to the door 18 and pivotally coupled to the frame 12.

Referring to FIG. 10, illustrated therein is a hinge pin 614 made in accordance with another embodiment of the present invention. The hinge pin 614 is similar in some respects to the hinge pins described previously, and similar elements have similar reference numerals. For example, the hinge pin 614 includes a pin body 620 having a first end 622 and a second end 624, a threaded portion 626, a grease nipple portion 628, outer bearing surfaces 630A, 6306, and 630C, a cross-bore 632 and a longitudinal bore 634 defining a lubrication passageway 636, and a friction surface 642.

One difference is that the threaded portion 626 is located proximal to the first end 622 along with the grease nipple portion 628 such that the longitudinal bore 634 extends through the threaded portion 626. This arrangement allows attachment of a sealing nut (not shown) that can be used as a coupling portion to couple the hinge pin 614 to the vehicle door (as with the hinge pins 14 and 16) or the vehicle frame (as with the hinge pin 514) while also providing a cap for keeping lubricant within the lubrication passageway 636.

Another difference is that the hinge pin 614 includes a pin head 640 instead of a flange with a hexagonal cross-section (like the flange 40). Notwithstanding the difference in shape, the pin head 640 still acts as a flange in the sense that it cooperates with the threaded portion 626 to define a coupling portion for coupling the hinge pin 614 to the vehicle door or the vehicle frame.

Another difference is that the outer bearing surface of hinge pin 614 has a central outer bearing surface portion 630B of reduced diameter. In particular, the pin body 620 includes a first bearing surface portion 630A extending from the central outer bearing surface portion 630B toward the first end 622, and a second bearing surface portion 630C extending from the central outer bearing surface portion 630B toward the second end 624 (e.g. toward the flange 640). As shown the central outer bearing surface portion 630B has a diameter smaller than both the first and second outer bearing surface portions 630A and 630C. The cross-bore 632 extends outward to the reduced diameter central outer bearing surface portion 630B, which facilitates the flow of lubricant to the central outer bearing surface portion 630B and the adjacent outer bearing surface portions 630A and 630C.

The hinge pin 614 also includes a knurled friction surface 642 proximal to the second end 624. The friction surface 642 is longer in comparison to the friction surface of the hinge pins described previously, which may provide a more secure mounting point for fixedly coupling the hinge pin 614 to the vehicle frame or door.

Another difference is that the hinge pin 614 is longer in comparison to the other hinge pins, which allows a single hinge pin to pivotally couple the door to the frame. For example, with reference to FIG. 6, the hinge pin 614 may extend downward through both mounting plates 210 and 212 so as to fixedly couple the hinge pin 614 to the frame, and an arm of the door may be straddle mounted to the hinge pin between the mounting plates 210 and 212 so as to pivotally couple the hinge pin to the door.

Referring to FIG. 11, illustrated therein is a hinge pin 714 made in accordance with another embodiment of the present invention. The hinge pin 714 is similar in many respects to the hinge pin 614 described previously with reference to FIG. 10, and similar elements have similar reference numerals incremented by one hundred. For example, the hinge pin 714 includes a pin body 720 having a first end 722 and a second end 724, a grease nipple portion 728, outer bearing surface portions 730, a cross-bore 732 and a longitudinal bore 734 defining a lubrication passageway 736, a pin head 740, and a friction surface 742.

One difference is that the threaded portion 626 has been replaced by another type of fastening portion, namely, a groove 726 (also referred to as an annular recess) that is sized and shaped to receive a circlip (not shown) such as an e-clip or a c-clip. When the circlip is placed in the groove 726, the circlip forms a collar for coupling the hinge pin 714 to the vehicle door or the vehicle frame between the pin head 740 and the circlip.

While some embodiments described herein may refer to specific types of coupling portions for coupling the pin body to the vehicle frame (such as combinations of threaded portions, friction surfaces, flanges, or grooves for receiving circlips), the coupling portions may have other configurations (for example, by replacing one or more of the threaded portions, friction surfaces, flanges, grooves for receiving circlips, with another suitable coupling device).

Another difference between the hinge pin 714 and the hinge pin 614 is that the friction surface 742 of the hinge pin 714 is not knurled like the friction surface 642 of hinge pin 614. Knurling is not necessary because the friction surface 742 is sized to fit tightly into an aperture of the hinge, for example, by hammering the hinge pin 714 into place.

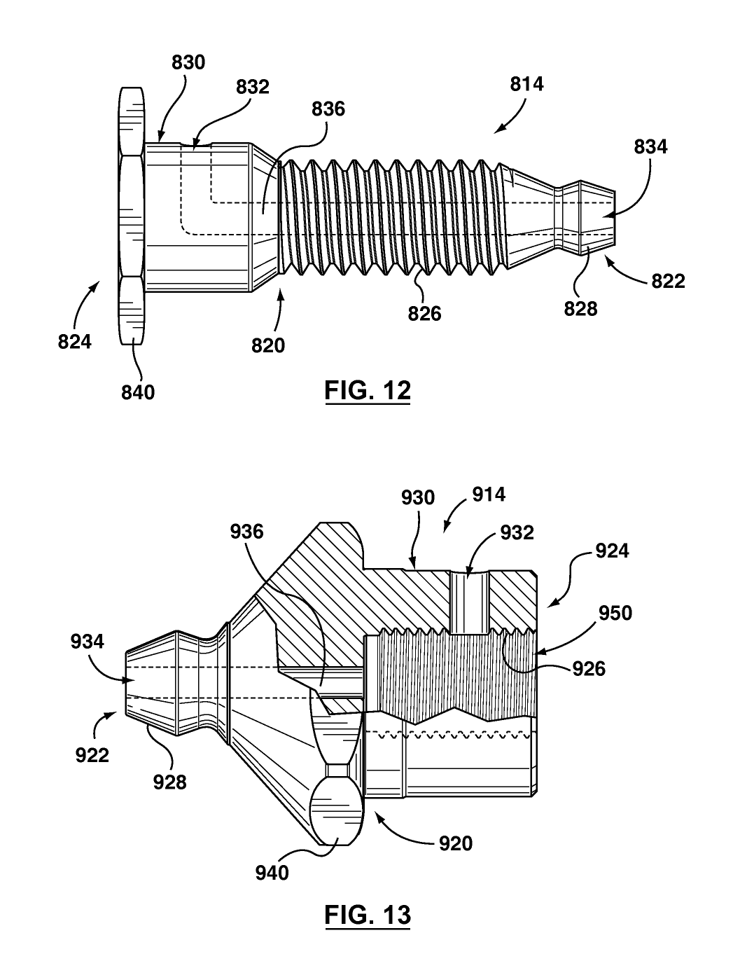

Referring to FIG. 12, illustrated therein is a hinge pin 814 made in accordance with another embodiment of the present invention. The hinge pin 814 is similar in some respects to the hinge pins described previously, and similar elements have similar reference numerals. For example, the hinge pin 814 includes a pin body 820 having a first end 822 and a second end 824, a threaded portion 826, a grease nipple portion 828, an outer bearing surface 830, a cross-bore 832 and a longitudinal bore 834 defining a lubrication passageway 836, and a flange 840.

The hinge pin 814 is similar to the hinge pin 614 in the sense that the threaded portion 826 is located proximal to the first end 822.

One difference is that the bearing surface 830 has an increased diameter compared to other portions of the pin body (e.g. the threaded portion 826).

Another difference is that the bearing surface 830 is located adjacent to the flange 840 and adjacent to the threaded portion 826. Unlike the hinge pin 614, there are no separate bearing surface portions 620A and 620C of increased diameter.

When installed, both the door and the frame are coupled to the hinge pin 814 along the bearing surface 830. For example, with reference to FIG. 6, the bearing surface 830 of the hinge pin 814 may be aligned with both the aperture 214 in the upper mounting plate 210 and the aperture 221 in the upper arm 220 of the hinge strap 10. In some embodiments, a bushing may be inserted into the apertures 214 and 221 and the bushing may receive the hinge pin 814 so as to be aligned with the bearing surface 830.

Referring to FIG. 13, illustrated therein is a hinge pin 914 made in accordance with another embodiment of the present invention. The hinge pin 914 is similar in some respects to the hinge pins described previously, and similar elements have similar reference numerals. For example, the hinge pin 914 includes a pin body 920 having a first end 922 and a second end 924, a grease nipple portion 928, an outer bearing surface 930, and a cross-bore 932 and a longitudinal bore 934 defining a portion of a lubrication passageway 936, and a flange 940.

One difference is that the pin body 620 includes a second longitudinal bore 950 extending from the second end 924 toward the first end 922. The second longitudinal bore 950 also has an internal threaded portion 926 therein (as opposed to an external threaded portion as in previous embodiments) for receiving a male threaded plug or bolt (not shown) so as to couple the hinge pin 914 to the vehicle door or the vehicle frame.

Another difference is that the outer bearing surface 930 overlies the second longitudinal bore 950 and the internal threaded portion 926. As such, the cross-bore 932 extends radially inward from the outer bearing surface 930 to the second longitudinal bore 950. Furthermore, the lubrication passageway 936 extends through the longitudinal bore 934 and into the second longitudinal bore 950, and then out through the cross-bore 932 to the outer bearing surface 930.

When installing the hinge pin 914, the internal threaded portion 926 receives the male threaded plug or bolt (not shown). Once installed, the male threaded plug (not shown) might partially block the lubrication passageway 936 and thereby restrict the flow of the lubricant from the grease nipple 928, through the longitudinal bores 934 and 950, and out the cross-bore to the bearing surface 930. However, some lubricant might flow between the threads of the internal threaded portion 926 and the threaded plug (not shown) so as to provide lubrication to the outer bearing surface 930.

Similar to the hinge pin 814, the hinge pin 914 is generally coupled to both the door and the frame along the bearing surface 930.

While the embodiments herein describe the hinge pins with reference to installation of vehicle doors on vehicle frames, the hinge pins may be used for different purposes, for example, installing doors in buildings, installing hinges on machine parts, and the like.

What has been described is merely illustrative of the application of the principles of the embodiments. Other arrangements and methods can be implemented by those skilled in the art without departing from the spirit and scope of the embodiments described herein.

1. A hinge pin for pivotally connecting a door to a frame, the hinge pin comprising:
(a) a pin body extending along a pivot axis between a first end and an opposing second end, the pin body having:
(i) an outer bearing surface located between the first and second ends, the bearing surface being shaped to enable the door to pivot relative to the frame about the pivot axis;
(ii) at least one cross-bore extending radially inward from the outer bearing surface into the pin body;
(iii) a longitudinal bore extending into the pin body from the first end to the cross-bore, wherein the longitudinal bore and the cross-bore together form a lubrication passageway extending from the first end of the pin body to the outer bearing surface; and
(iv) coupling portions for coupling the pin body to the door and the frame;
(b) a grease nipple portion extending longitudinally from the first end of the pin body, the grease nipple portion being shaped to be coupled to a grease applicator for injecting grease into the lubrication passageway, wherein the grease nipple portion is integrally formed with the pin body.

2. The hinge pin of claim 1, wherein the lubrication passage has a diameter greater than about 1/16 of an inch.

3. The hinge pin of claim 2, wherein the lubrication passage has a diameter of between about 1/16 of an inch and ⅛ of an inch.

4. The hinge pin of claim 1, wherein the longitudinal bore has a bottom, and wherein the cross-bore intersects the longitudinal bore at the bottom of the longitudinal bore.

5. The hinge pin of claim 1, wherein the grease nipple portion has a bulbous shape.

6. The hinge pin of claim 5, wherein the grease nipple portion is shaped as a truncated bicone.

7. The hinge pin of claim 1, wherein the coupling portions comprise:
(a) a first coupling portion for pivotally coupling the pin body to one of the door and the frame; and
(b) a second coupling portion for fixedly coupling the pin body to the other of the door and the frame.

8. The hinge pin of claim 7, wherein the first coupling portion includes a flange and a fastening portion for receiving a fastener so as to secure one of the door and the frame between the flange and the fastener.

9. The hinge pin of claim 8, wherein the flange is located between the bearing surface and the first end.

10. The hinge pin of claim 8, wherein the flange is located between the bearing surface and the second end.

11. The hinge pin of claim 8, wherein the fastening portion is a threaded portion for threadably receiving a threaded fastener so as to secure one of the door and the frame between the flange and the threaded fastener.

12. The hinge pin of claim 11, wherein the threaded portion is an external threaded portion.

13. The hinge pin of claim 8, wherein the fastening portion is located between the bearing surface and the second end.

14. The hinge pin of claim 8, wherein the fastening portion is located between the bearing surface and the first end.

15. The hinge pin of claim 1, wherein the second coupling portion includes a friction surface for coupling the pin body to the other of the door and the frame.

16. The hinge pin of claim 15, wherein the friction surface is located between the bearing surface and the first end.

17. The hinge pin of claim 15, wherein the friction surface is located between the bearing surface and the second end.

18. A kit for pivotally connecting a door to a frame, the kit comprising an upper hinge pin and a lower hinge pin, each of the upper and lower hinge pins comprising:
(a) a pin body extending along a pivot axis between a first end and an opposing second end, the pin body having:
(i) an outer bearing surface located between the first and second ends, the bearing surface being shaped to enable the door to pivot relative to the frame about the pivot axis;
(ii) at least one cross-bore extending radially inward from the outer bearing surface into the pin body;
(iii) a longitudinal bore extending into the pin body from the first end to the cross-bore, wherein the longitudinal bore and the cross-bore together form a lubrication passageway extending from the first end of the pin body to the outer bearing surface; and
(iv) coupling portions for coupling the pin body to the door and the frame;
(b) a grease nipple portion extending longitudinally from the first end of the pin body, the grease nipple portion being shaped to be coupled to a grease applicator for injecting grease into the lubrication passageway, wherein the grease nipple portion is integrally formed with the pin body.

19. The kit of claim 18, further comprising a hinge strap for securing the door to the upper hinge pin and the lower hinge pin.

20. The kit of claim 18, wherein the coupling portions comprise:
(a) a first coupling portion for pivotally coupling the pin body to one of the door and the frame; and
(b) a second coupling portion for fixedly coupling the pin body to the other of the door and the frame.
